(19) United States
(12) Patent Application Publication
(10) Pub. No.: US 2021/0355900 A1
(43) Pub. Date: Nov. 18, 2021

(54) INTELLIGENT AUTOMOTIVE COMPONENT

(71) Applicant: Clarence Wheeler, Atlanta, GA (US)

(72) Inventor: Clarence Wheeler, Atlanta, GA (US)

(73) Assignee: Nurosphere Inc., Atlanta, GA (US)

(21) Appl. No.: 17/167,312

(22) Filed: May 29, 2021

Related U.S. Application Data
(63) Continuation-in-part of application No. 16/214,118, filed on Jan. 25, 2019, now Pat. No. 11,092,128.
Application No. 16/214,118 is a continuation-in-part of application No. 16/594,065, filed on Dec. 30, 2019, now Pat. No. 11,125,199.

(51) Int. Cl. F02N 11/08; G07C 9/00

(52) U.S. Cl. CPC F02N 11/087; G07C 2009/00373; G07C 9/00309

(57) ABSTRACT

An intelligent automotive component such as an engine starter. The intelligent automotive component having an power-link apparatus disposed within an housing comprising a circuitry that furthers allocates and restricts power supply to one or more components of the intelligent automotive component. The intelligent automotive component comprises an control apparatus such as an key fob that allows wireless communication between the intelligent automotive component and key fob.

### BACKGROUND OF THE INVENTION

### Field of the Invention

This invention relates to the field of automotive components and systems.

### Related Art

Their are numerous automotive components and with remote control functions in order to control the automotive components systems as of today. One example of this may be a system having a wireless transmitter configured to distribute a signal to the automotive component in order to control power distribution to the automotive component. Such automotive components may be for example a fuel pump, engine starter or the ignition circuit. In other implementation, the wireless transmitter may be configured to remotely start the automobile upon distributing the signal to a transmitter of the automobile. Disclosed in the current invention describes a automotive system having advantage features and implementation that introduces a innovated system and method for activating and deactivating a automotive component.

### BRIEF SUMMARY OF THE PRESENT INVENTION AND ADVANTAGES

The present invention relates to the field of an intelligent automotive components. One aspect of the intelligent automotive component is to control an automotive component from a external apparatus such as an key fob. This type of intelligent component can be for but not limited to automobile's, boats, RV's, ATV, motorcycles, tractors, mowers, or anything that requires an specified automotive component as the one later discussed. The intelligent automotive component is configured to be mounted/installed to an said location, weather be inside of the fuel tank, onto the frame, under the hood, or wherever the OEM component is said to be mounted/installed. Examples of an intelligent automotive component may be a fuel pump, engine starter, motor-controller etc. Further, the intelligent automotive component include various internal and external components to preform an plurality of duties to keep the component operating efficiently. The intelligent automotive component includes an power-link apparatus circuitry configured to allocate or restrict an current to and from one or more components of the intelligent automotive component.

### BRIEF DESCRIPTION OF THE SEVERAL VIEWS OF THE DRAWINGS

A more complete understanding of the present invention is derived by referring to the detailed description and claims when considered in connection with the Figures, wherein like reference numbers refer to similar items throughout the Figures.

FIG. 1 is a block diagram describing the key fob.

FIG. 2 is a block diagram illustrating the power-link apparatus that performs power management according to an embodiment of the inventive concept.

FIG. 3A shows an diagram of additional components that allows the intelligent automotive component to operate as described according to one embodiment.

FIG. 3B shows a schematic diagram of the circuitry of additional components according to another embodiment.

FIG. 4A shows an diagram of the primary power functioning unit circuitry in conjunction during enable mode according to one embodiment.

FIG. 4B shows an diagram of the secondary power functioning unit circuitry in conjunction during disable mode according to another embodiment.

FIG. 5 shows an diagram of the power-link component circuitry in conjunction during an power management operational aspect of the circuitry according to one embodiment.

FIG. 6 shows a block diagram of a conventional engine-starter according to one embodiment.

FIG. 7 show a block diagram of the present intelligent automotive component according to one embodiment.

FIG. 8 is a illustration of the intelligent automotive component according to one embodiment.

FIG. 9 is a exemplary illustration of a aspect of the coils of the intelligent automotive component according to one embodiment.

FIG. 10 illustrates a cut-out view of the intelligent automotive component according to one embodiment.

FIG. 11 is a flowchart of a process for remotely activating the intelligent automotive component in accordance with an exemplary embodiment of the present invention.

FIG. 12 is a flowchart of a process for remotely deactivating the automobile intelligent automotive component in accordance with an exemplary embodiment of the present invention.

### DESCRIPTION OF THE EMBODIMENT(S)

The numerous innovative teachings of the present invention will be described with particular reference to the preferred embodiments disclosed herein. However, it should be understood that the embodiments described provided only a few examples of the many advantages uses and innovative teachings herein. In general, statements made in the specifications of the present application do not necessarily delimit any of the various claimed inventions. Moreover, some statements may apply to some inventive features, but not to others. The following described automotive components and systems may be used to preform a duty or operative take and may communicate and receive data from an external terminal to preform a task.

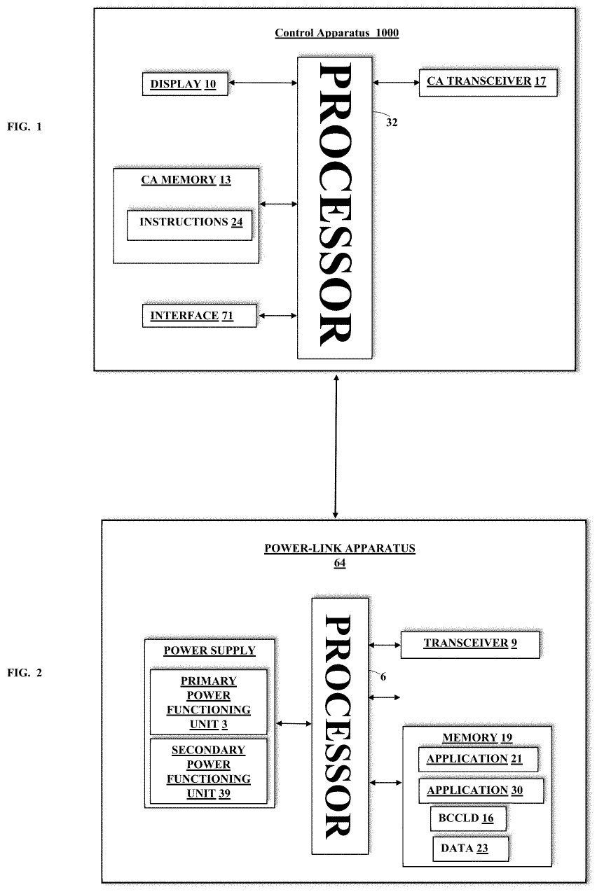

FIG. 1 illustrates a functional block diagram of control apparatus 1000 for remotely activating and deactivating intelligent automotive component(s), in accordance with an exemplary embodiment of the present invention.

As shown in FIG. 1, control apparatus 1000 comprises one or more CA processor(s) 32, CA transceiver 7, display 10 and one or more memory(s) 13. Control apparatus 1000 illustrated in the present discloser may be better identified as a key fob, smart-phone or any other external apparatus configured to distribute and obtain one or more signal wirelessly known to one skilled in the art(s).

Control apparatus 1000 may be configured to execute many task and operations in order to distribute one or more remote activation or deactivation request signal(s) to intelligent automotive component via CA transceiver 7 in order to activate or deactivate intelligent automotive component(s).

Control apparatus 1000 may further be configured to obtain one or more states (e.g., and status of intelligent automotive component via CA transceiver 7 and display the state on display 10. Control apparatus 1000 comprises one or more CA processor(s) 32 configured to provide instructions to CA transceiver 7 to distribute one or more remote activation or deactivation request signal(s) to intelligent automotive component(s). CA processor(s) 32 is further configured to provide instructions for displaying one or more notification on display 10, in response to obtaining an component state signal (CSS) via intelligent automotive component notifying the user the state (e.g., activation or deactivation) of the one or more intelligent auto motive component(s) or one or more electrical components (e.g., battery) of intelligent automotive component(s).

CA processor(s) 32 may also execute one or more program(s) 24 stored on memory(s) 13 that controls the overall operations of processing system 1000. CA processor(s) 32 may comprise any type of processor or multiple processors, single integrated circuits such as a microprocessor, or any suitable number of integrated circuit devices and/or circuit boards working in cooperation to accomplish the functions of a processing unit. Specifically, CA transceiver 7 can be configured to distribute one or more activation or deactivation request signal(s) to intelligent automotive component(s) under the control of one or more CA processor(s) 32. CA transceiver 7 can also be configured to obtain one or more component state signal(s) (CSS) indicating the status of intelligent automotive component(s).

Control apparatus 1000 comprise one or more memory(s) 13 that stores one or more program(s) 24 that executes one or more instructions and processes. Memory(s) 13 may further store various types of data to support the processing, control, or storage requirements of control apparatus 1000. Examples of such data may include an operating program, software instructions for controlling control apparatus 1000 execution commands etc. Memory(s) 13 may be implemented using any type of volatile and non-volatile memory or storage devices. Such devices may include random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, cardtype memory, or other similar memory or data storage device or any type of suitable memory. Memory(s) 13 stores an application 24 that, when processed by one or more CA processor(s) 32, enables CA processor(s) 32 to: obtain an component state signal (CSS) via intelligent automotive component, in response to obtaining component state signal (CSS) application 24 is configured to display the contextual status of intelligent automotive component associated with the obtained component state signal (CSS) on display 10. For instance, the state of intelligent automotive component may be displayed on display 10 labeled “IAC Activated or IAC Deactivated” other suitable identifications may be displayed to notify the user the state of intelligent automotive component.

Furthermore, memory(s) 13 storing application 24 is an example of a computer program product, comprising a non-transitory computer usable medium having a computer readable program code adapted to be executed to implement a method, for example a method stored in application 24. Display 10 that may include an panel. The panel and the touch panel may be configured with one module. Display 10 further includes a control circuit for controlling the panel. Display 10 may be implemented using known display technologies such as a liquid crystal display (LCD), a thin film transistor-liquid crystal display (TFT-LCD), an organic light-emitting diode display (OLED), active matrix organic light-emitting diode (AMOLED) or a three-dimensional display. Display 10 may further be coupled to processing system 5, in order to obtain instructions from CA processor(s) 32. Control apparatus 1000 comprises interface 2 that may allocate communication to an processing system via an user input, a system operator, and/or another computer system, and can be implemented using any suitable method and apparatus.

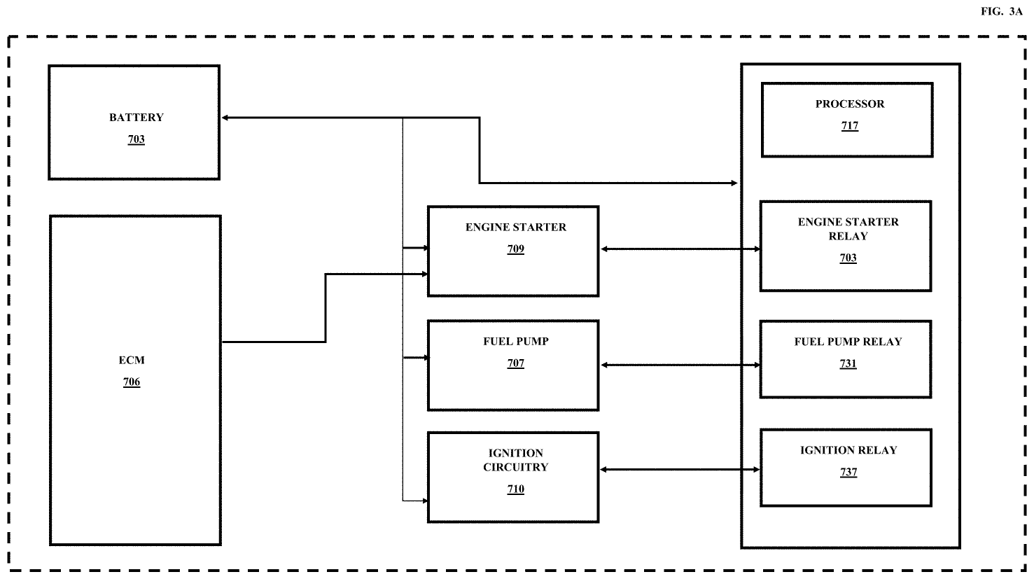

FIG. 2 illustrates a functional block diagram of power-link apparatus 64 of intelligent automotive component 1 for activation and deactivation the intelligent automotive component 1, in accordance with an exemplary embodiment of the present invention.

Intelligent automotive component(s) (IAC) (e.g., engine starter) 1 comprises power-link apparatus 64 disposed within at least one area and coupled to at least one component of intelligent auto motive component 1 that controls the activation and deactivation operations. Specifically, power-link apparatus 64 includes processor(s) 6, memory(s) 19, transceiver 9, an power supply comprising primary power functioning unit 3 and secondary power functioning unit 39. Power-link apparatus 64 also include portion A hold-in connector and portion B hold-in connector to obtain input power from the automobile battery and distribute power to the hold-in coils.

IAC processor(s) 6 can be configured to determine if at least an remote activation or deactivation request signal has been obtained via control apparatus 1000, distributes one or more component state signal(s) (CSS) to CA transceiver 14 notifying the user the state (e.g., activated or deactivated) of intelligent automotive component(s) 1 thereof. In addition, processor(s) 6 execute one or more programs stored on memory(s) 19 that controls the overall operations of intelligent automotive components 1.

CA processor(s) 6 may comprise any type of processor or multiple processors, single integrated circuits such as a microprocessor, or any suitable number of integrated circuit devices and/or circuit boards working in cooperation to accomplish the functions of a processing unit. Further, intelligent automotive component(s) comprises an transceiver 14 configured to distribute an components state signal (CSS) and/or instructions to control apparatus 1000 under the control of processor(s) 6. Transceiver 14 can be configured to obtain one or more activation or deactivation request signal(s) from control apparatus 1000 via under the control of processor(s) 6.

Memory(s) 19 stores application 21 that executes one or more instructions and processes. The memory(s) 19 may also stores various types of data to support the processing, control, or storage requirements of intelligent automotive component 1. Examples of such data may include an operating program, software instructions for controlling intelligent automotive component 1 execution commands. Memory(s) 19 may be implemented using any type of volatile and non-volatile memory or storage devices. Such devices may include random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, cardtype memory, or other similar memory or data storage device or any type of suitable memory.

Power-link apparatus 64 comprises primary power functioning unit 3 configured to distribute voltage power (e.g., current) to processing circuit 44 and the one or more electrical components of power-link apparatus 64 via the automobile battery.

Power-link apparats 64 comprises secondary power functioning unit 39 configured to allocate or restrict voltage power (e.g., current) to portion B hold-in upon processor 6 generating and distributing a first switch control signal (FSCS) to power functioning controller 42. Primary and secondary power functioning unit (3, 39) may be the like(s) of an power management module, power management IC (PMIC), power control circuit or any known power control system known to one skilled in the art(s). In addition, primary and secondary power function unit (3, 39) circuits may comprises transistor, resistors, capacitor, voltage regulator, logic gates, inverters, etc. configured to obtain, hold and distribute an suitable amount of operation power to the one or more electrical components.

Various embodiments described herein may be implemented in a computer-readable medium using computer software. The various embodiments may also be implemented in hardware. A hardware implementation may be implemented using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein. Some embodiments are implemented by processor(s) (6, 32) and power functioning controller 20. A software implementation of the embodiments described herein may be implemented with separate software modules, such as procedures and functions, each of which perform one or more of the functions and operations described herein. The software code may be implemented with a software application written in any suitable programming language and may be stored in memory(s) (13, 19) for execution by the one or more processor(s) (6, 32) and/or power functioning controller (20, 42).

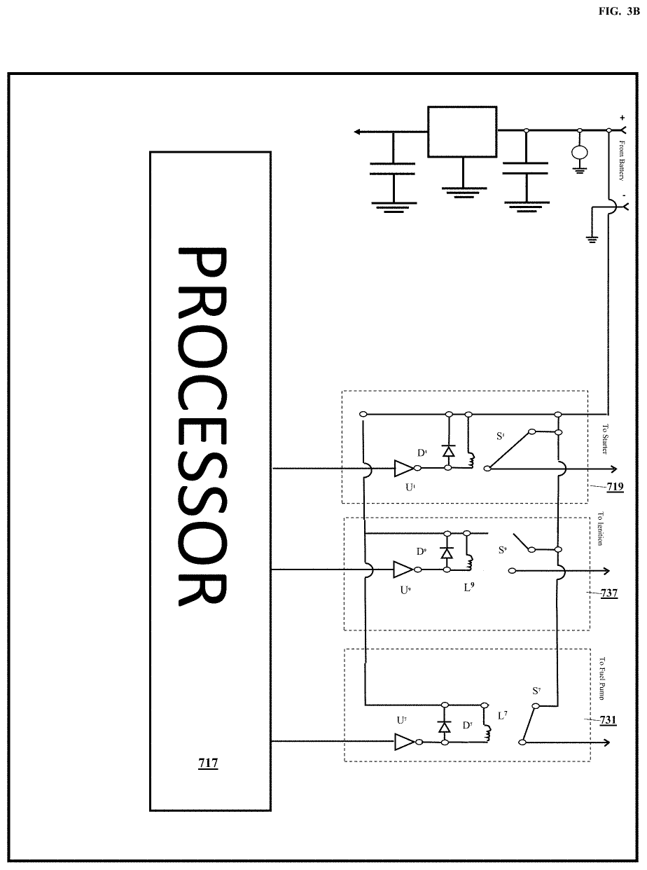

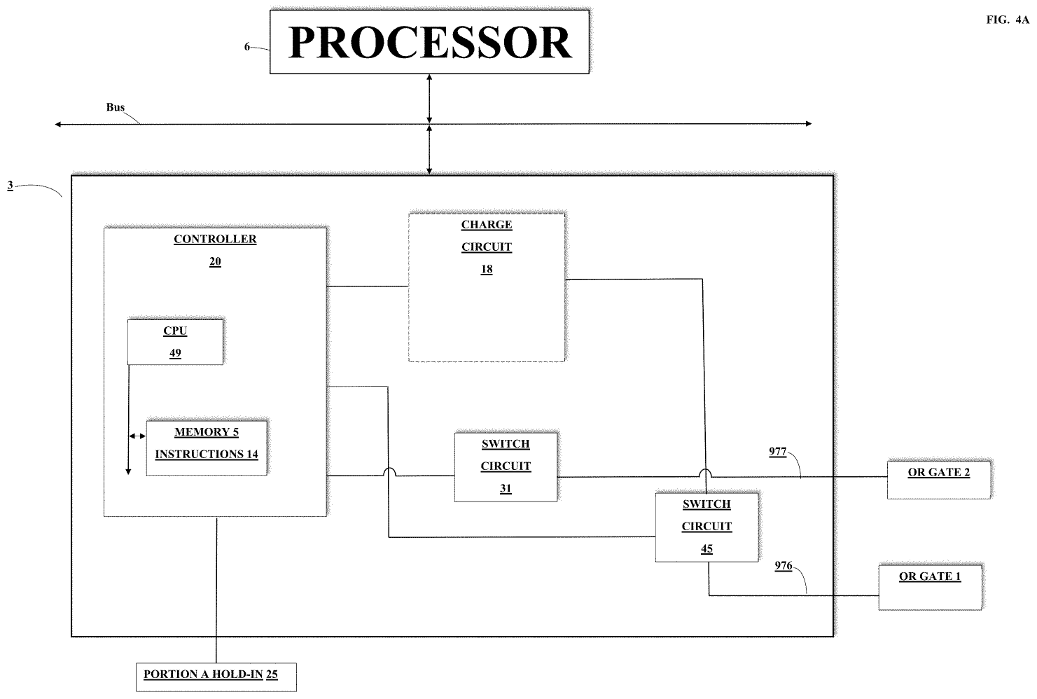

FIGS. 3A & 3B shows a block diagram of the preferred embodiment of one or more additional components that may be coupled to the automobile and intelligent automotive component. Automobile includes battery 703, engine control module (ECM) 706, engine starter (IAC) 709, fuel pump (IAC) 707 and ignition circuit 710. Fuel box 721 can include processor 717, engine starter relay 719, fuel pump relay 731 and ignition circuit relay 737. In addition, processor 717 can be coupled to engine starter relay 719, fuel pump relay 731 and ignition circuit relay 737. In such implementation battery 703 can be coupled to engine starter (IAC) 709, fuel pump (IAC) 707 and ignition circuit 710. Battery 703 can be a standard 12V or 24V automotive battery. Engine control module (ECM) 706 can be coupled to engine starter motor (IAC) 709, fuel pump (IAC) 707 and ignition circuit 710.

Further, engine control module (ECM) 706 can comprise the standard engine control module that is equipped in every automobile to monitor and control engine conditions. Engine starter relay 719 can comprises a processor controller and relay system controlled by processor 717, and can be coupled to a input of engine starter (IAC) 709. Engine starter relay 719 can be configured connect engine starter (IAC) 709 to the positive terminal of battery 703.

And on, engine starter relay 719 is preferably configured to allow a power signal to be sent to engine starter (IAC) 709 to perpetually keep currents supplied to the power-link apparatus when the ignition is at the OFF, RUN or START position, and to start the automobile when the ignition is at the START position. Engine starter relay 719 can include a operational amplifier U¹ connected to a diode and inductor L¹, with a switch connected thereto, such that inductor L¹ is configured to control a state of switch S¹ to keep at a closed position to perpetually allocate power (e.g., current) to engine starter (IAC) 709. For example, on conventional automobiles inductor L¹ is configured to control a state of switch S¹ of engine starter relays to a open position restricting power (e.g., current) to a engine starter when the ignition is turned to the OFF position, and inductor L¹ is configured to control a state of switch S¹ to the close position allocating power to the engine starter when the ignition is turned back to the ACC, RUN or SART position. Whereby as described in the current invention inductor L¹ is configured to control a state of switch S¹ to the close position at all times weather the position of the ignition is at the OFF, ACC, RUN or START position to allocate power (e.g., current) to the power-link apparatus in order to power the power-link apparatus, and to allocate a higher power to energize the coils of engine starter (IAC) 709 when the ignition is turned to the START position.

However, fuel pump relay 731 can comprise processor 717 and relay system to couple a terminal of fuel pump (IAC) 707 to the positive terminal of battery 703 or to the ground circuit of the automobile. Ignition circuit relay 737 can comprise processor 717 and a relay system to activate ignition circuit 710 for internal combustion process to take place. Ignition circuit relay 737 can include an operational amplifier U⁹ connected to diode D⁹ and inductor L⁹, with switch S⁹ connected thereto, such that inductor L⁹ can control whether or not switch S⁹ is opened or closed.

Further, fuel pump relay 731 is also preferably configured to allow a power signal to be sent to fuel pump (IAC) 707 to perpetually keep currents supplied to the power-link apparatus when the ignition is at the OFF, RUN or START position. Fuel pump relay 731 can include an operational amplifier connected to diode D⁷ and an inductor L⁷, with switch S⁷ connected thereto, such that inductor L⁷ is configured to control a state of switch S⁷ to keep at a closed position to perpetually allocate power to fuel pump (IAC) 707. For example, on conventional automobiles inductor L⁷ is configured to control a state of switch S⁷ of fuel pump relays to a open position restricting power (e.g., current) to a fuel pump when the ignition is turned to the OFF position, and inductor L⁷ is configured to control a state of switch S⁷ to the close position allocating power to the fuel pump when the ignition is turned back to the ACC, RUN or START position. Whereby as described in the current invention inductor L⁷ is configured to control a state of switch S⁷ to the close position at all times weather the position of the ignition is at the OFF, ACC, RUN or START position.

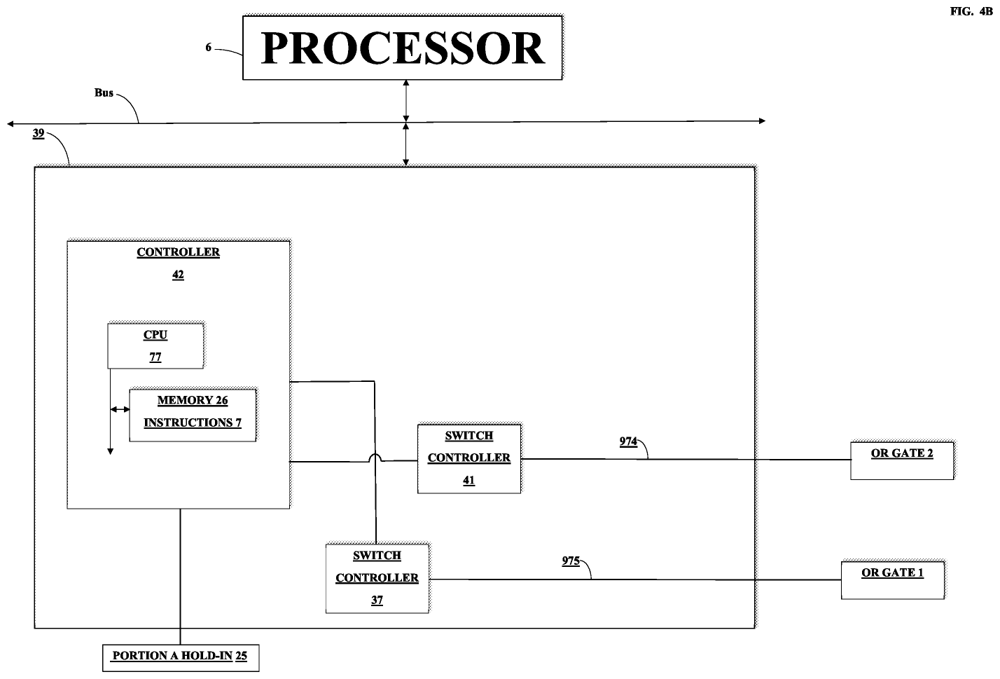

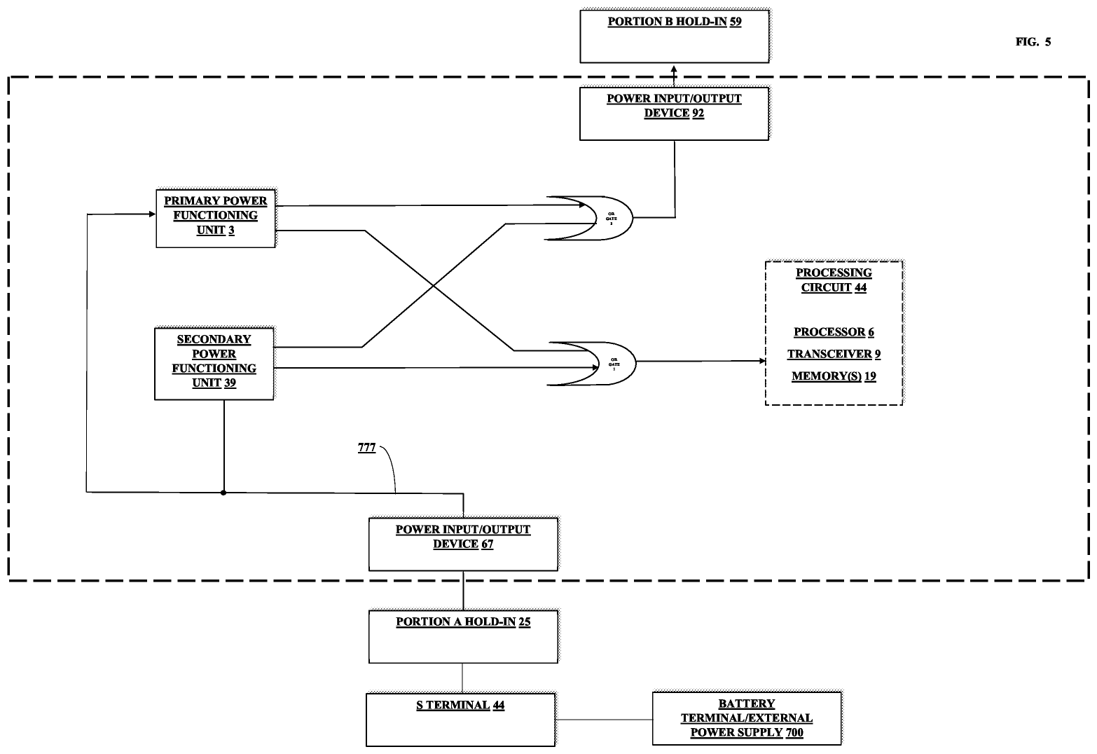

Accordingly FIG. 4A-4B is an illustration of the power supply circuit of the power-link apparatus 64, primary power functioning unit 3 is configured to distribute operation power (e.g., current) to processing circuit 44 via ₒᵣgate₁.

Secondary power functioning unit 39 is configured to distribute power (e.g., current) to portion B hold-in 59 to start the automobile via ₒᵣgate₂ in response to processor(s) 6 obtaining remote activation request signal and the user of the automobile turning the ignition to the start position, and can also restrict power (e.g., current) to portion B hold-in 59 in response to processor(s) 6 obtaining remote deactivation request signal, via control apparatus 1000.

Power-link apparatus 64 comprises bus 1001 for connecting primary power functioning unit 3 and secondary power functioning unit 39 to processor(s) 6 and other electrical components for delivering one or more communication signals (e.g., switch control signals, messages, data or instructions) between the components. Primary power functioning unit 3 comprises power functioning controller 20, switch circuit ₂31, switch circuit ₆45 and charge circuitry 18. Power functioning controller 20 is configured to control one or more task operations of primary power functioning unit 3 such as controlling the overall aspect of allocating and restricting of power of switch circuits.

Power functioning controller 20 configured to stabilize input power (e.g., current) supplied by portion A hold-in 25 via battery terminal. Power stabilizer controller 18 can also convert AC power (e.g., current) from battery terminal into DC power. DC power may be used to power processing circuit 44 and other components of power-link apparatus 64.

Primary power functioning unit 3 comprises switch circuit ₆45 having duties of switching between opening and closing the circuitry of power signal path 976 in order to allocate or restrict operational power (e.g., current) to processing circuit 44 via ₒᵣgate₁, and switch circuit₂ 31 can having duties of switching between opening circuitry of power signal path 977 to allocate or restrict voltage power (e.g., current) to hold-in windings 36 via ₒᵣgate₂.

Switch circuitry ₆45 and switch circuit ₂31 can be a switching circuitry having an operational amplifier U connected to a diode D and an inductor L, with at least one switch S connected thereto, such that inductor L can control whether or not switch is opened or closed base upon a change of resistance of power (e.g., current) suppled to switch circuitry ₆45 and switch circuit ₂31 under the control of power functioning controller 20. For instance, inductor L of switch circuitry ₆45 and switch circuit ₂31 can be configured control the closing of switch S in order to allocate power (e.g., current) based upon power functioning controller 20 distributing power signals (e.g., current) to switch circuitry ₆45 and switch circuit ₂31 and the power signal (e.g., current) energizing the coils of inductor L attracting the switch S to close the circuit of respective power signal paths respectively. And the inductor L of switch circuitry ₆45 and switch circuit ₂31 can be configured control the opening of switch S to restrict power (e.g., current) based upon power functioning controller 20 not distributing power signals (e.g., current) to switch circuitry ₆45 and switch circuit ₂31 this causes the coils of inductors L to not be energized and retracting the switch S to open the circuit of respective power signal paths respectively FIG. 3C.

Primary power functioning unit 3 comprises charge circuit 18 having duties of distributing temporary operational power (e.g., current) to processing circuit 44 via power signal path 976 via ₒᵣgate₁. Charge circuit 18 can be a series capacitor circuit for suppling power (e.g., current) to processing circuit 44 for a temporary period of time in response to the ignition turned to the START position.

Power functioning controller 20 comprises Central Processing Unit (CPU) 49 that comprises one or more cores. Power functioning controller 20 comprises Random Only Memory (ROM) 50 for storing one or more control programs to control the one or more switch circuits (e.g., distributing power signals (e.g., current)) in response to obtaining an switch control signal via processor(s) 6. Power functioning controller 20 also comprises Random Access Memory (RAM) 51 for storing signals and data obtained by processor(s) 6, or for use as an memory space for an operation preformed by primary power functioning unit 3. CPU 49, ROM 50 and RAM 51 may be interconnected via an internal bus.

Secondary power functioning unit 39 comprises power functioning controller 42, switch circuit₃ 41 and switch circuit ₅37. Power stabilizer controller 40 can be configured to stabilize input power (e.g., currents) supplied by portion A hold-in 25 via battery terminal. Power stabilizer controller 40 can also convert AC power from battery terminal into DC power. DC power may be used to power hold-in windings via ₒᵣgate₂ in response to portion B hold-in 36 obtaining power.

Secondary power functioning unit 39 comprises switch circuit ₃41 having duties of switching between opening or closing the circuitry of power signal path 974 in order to allocate or restrict power (e.g., current) to portion B hold-in 59 via ₒᵣgate₂ in response to processor 6 obtaining a remote activation or deactivation request signal via control apparatus 1000.

Switch circuit ₅37 can have duties of switching between opening or closing the circuitry of power signal path 975 on order to allocate or restrict power (e.g., current) to processing circuit 44 ₒᵣgate₁.

Switch circuitry ₃41 and switch circuit ₅37 can be a switching circuitry having an operational Amplifier U connected to a diode D and an inductor L, with at least one switch S connected thereto, such that inductor L can control whether or not switch S is opened or closed.

Power functioning controller 42 can be configured to control one or more task operations of secondary power functioning unit 39 such as controlling the switching of the switch circuit respectively FIG. 4D.

Power functioning controller 42 also comprises Central Processing Unit (CPU) 52 that comprises one or more cores. Random Only Memory (ROM) 53 can store one or more control programs to control the one or more switch circuits, in response to obtaining a switch control signal via processor(s) 6. Random Access Memory (RAM) 54 can store data and instructions to execute a task upon obtaining a remote activation or deactivation signal, or for use as an memory space for an operation preformed by secondary power functioning unit 39. CPU 52, ROM 53 and RAM 54 may be interconnected via an internal bus.

As illustrated, primary power functioning unit 3 and secondary power functioning unit 39 is coupled to processor(s) 6 via bus 1001 and whereby can be configured to obtain instruction and signals to execute one or more task.

The OR gates used in the present invention is an digital logic gate that implements logical disjunction it behaves according to the truth table; A HIGH output (1) results if one or both of the inputs to the gate are HIGH (1). If neither input is high, a LOW output (0) results. In another sense, the function of OR effectively finds the maximum between two binary digits, just as the complementary and function finds the maximum.

According to the present invention, during activation of intelligent automotive component 1 power (e.g., current) is allocated to processing circuit 44 by primary power functioning unit 3, this can be performed when power functioning controller 20 distributes power signals (e.g., current) to switch circuit ₆45 closing the circuitry of power signal path 976 to allocate power (e.g., current) to ₒᵣgate₁, and power (e.g., current) distributed to processing circuit 44 from secondary power functioning unit 39 is restricted at ₒᵣgate₁, this can be performed when power functioning controller 42 doesn't distributes power signals (e.g., current) to switch circuit ₅37 opening the circuitry of power signal path 975. For instance, during activation of intelligent automotive component 1 primary power functioning unit 3 is configured to distribute power (e.g., current) to processing circuit 44, in this case primary power functioning unit 3 power is high so the logic value input to ₒᵣgate₁ is 1 and secondary power functioning unit 39 is low so the logic value input to ₒᵣgate₁ is 0. Thus, in this circumstance, operation power is distributed to processing circuit 44 by primary power functioning unit 3.

Also, during activation of intelligent automotive component 1 power (e.g., current) is allocated to portion B hold-in 59 by secondary power functioning unit 39 via switch circuit ₃41, this can be performed when power functioning controller 42 distributes power signals (e.g., current) to switch circuit ₃41 closing the circuitry of power signal path 974 to allocate power (e.g., current) to ₒᵣgate₂, and power (e.g., current) distributed to portion B hold-in 59 from primary functioning unit 3 is restricted at ₒᵣgate₂, this can be performed when power functioning controller 20 doesn't distributes power signals (e.g., current) to switch circuit ₂31 opening the circuitry of power signal path 977.

For instance, during activation of intelligent automotive component 1 secondary power functioning unit 39 is configured to distribute power to hold-in windings 36, in this case secondary power functioning unit 39 power is high so the logic value input to ₒᵣgate₂ is 1 and primary power functioning unit 3 is low so the logic value input to ₒᵣgate₂ is 0. Thus, in this circumstance, operation power is distributed to hold-in windings 36 by secondary power functioning unit 39.

However, during deactivation of intelligent automotive component 1 power (e.g., current) is allocated to processing circuit 44 by primary power functioning unit 3 via switch circuit ₆45, this can be performed when power functioning controller 20 distributes power signals (e.g., current) to switch circuit ₆45 closing the circuitry of power signal path 976 to allocate power (e.g., current) to ₒᵣgate₁, and power (e.g., current) distributed to processing circuit 44 from secondary functioning unit 39 is restricted at ₒᵣgate₁, this can be performed when power functioning controller 42 doesn't distributes power signals (e.g., current) to switch circuit ₅37 opening the circuitry of power signal path 975. For instance, during activation of intelligent automotive component 1 primary power functioning unit 3 is configured to distribute power to processing circuit 44, in this case primary power functioning unit 3 power is high so the logic value input to ₒᵣgate₁ is 1 and secondary power functioning unit 39 is low so the logic value input to ₒᵣgate₁ is 0. Thus, in this circumstance, operation power is distributed to processing circuit 44 by primary power functioning unit 3.

However, during deactivation of intelligent automotive component 1 power (e.g., current) is restricted to hold-in windings 59 by secondary power functioning unit 39 via switch circuit₃ 41, this can be performed when secondary functioning controller 39 doesn't distributes power signals (e.g., current) to switch circuit ₃41 opening the circuitry of power signal path 974 via ₒᵣgate₂, and power (e.g., current) distributed to portion B hold-in 59 from primary functioning unit 3 is restricted at ₒᵣgate₂, this can be performed when power functioning controller 20 doesn't distributes power signals (e.g., current) to switch circuit ₂31 opening the circuitry of power signal path 977.

For instance, during deactivation of intelligent automotive component 1 primary power functioning unit 3 is configured to allocate power to processing circuit 44, in this case primary power functioning unit 3 power is high so the logic value input to ₒᵣgate₁ is 1 and secondary power functioning unit 39 is low so the logic value input to ₒᵣgate₁ is 0.

In other situation, do to engine starters requiring a higher voltage (e.g., current) to start the automobile when the ignition is turned to the START position primary power functioning unit 3 distributes power signal (e.g., current) to processing circuit 44 via charge circuit 18 discharging power signal (e.g., current) for a temporary period from the plurality of capacitors of charge circuit 18, in this instance controller 20 doesn't distribute power signals (e.g., current) to switch circuit ₆45 and charge circuit 18 in response to controller 18 not distributing power signals (e.g., current) charge circuit 18 discharge power signals (e.g., current) from the plurality of capacitors of charge circuit 18 to switch circuit ₆45 closing the circuit of power signal path 976 to allocate power signal (e.g., current) to processing circuit 44 via ₒᵣgate₁ until controller 20 determine the ignition is turned back to the OFF or ACC position, power signal (e.g., current) is then distributed to the processing circuit 44 via normal method as described above. For instance, when the ignition is turned to the OFF or ACC position power (e.g., current) is supplied to primary and secondary power functioning unit 3 & 39 at an LOW state from the battery terminal/external power supply 700, and when the ignition is turned to the START position power (e.g., current) is supplied to primary and secondary power functioning unit 3 & 39 at an HIGH state from the battery terminal/external power supply 700. In reference to the LOW and HIGH power states supplied to primary and secondary power functioning unit 3 & 39 one or more instructions stored in memory(s) 5 & 26 of controller 20 & 42 may be configured to determine the respective input power levels (e.g., current levels) input into primary and secondary power functioning unit 3 & 39 from the battery terminal/external power supply 700.

Thus, in this circumstance, operation power is distributed to processing circuit 44 by primary power functioning unit 39.

FIG. 5 illustrates the one or more power functioning units of the power-link apparatus 64 in cooperation with intelligent automotive component 1 for obtaining power (e.g., current) from the automobile battery terminal/external power supply 700 to distribute power (e.g., current) to one or more components of power-link apparatus 64 and intelligent automotive component(s) 1 in accordance with a preferred embodiment of the present invention.

In the light of the present invention, primary functioning unit 3 and secondary functioning unit 39 is configured to obtain power (e.g., current) from a power signal path 777 of power input/output device 67 via portion A hold-in 25 obtaining power from battery terminal/external power supply 700. Further, secondary functioning unit 39 is configured to distribute power (e.g., current) to portion B hold-in 59 in response to portion B hold-in 59 being communicable coupled to power input/output device 92.

In reference to FIGS. 4A & 4B, the power functioning circuitry of power-link apparatus 64. In accordance with the present invention comprises: primary power functioning unit 3 is configured to distribute main power to operate processing circuitry 44 via obtaining power (e.g., current) suppled by battery terminal/external power supply 700 and distributing the obtained power to processing circuitry 44 via ₒᵣgate₁; secondary power functioning unit 39 is configured to distribute power (e.g., current) to hold-in windings via secondary power functioning unit 39 obtaining power (e.g., current) from battery terminal/external power supply 700.

Secondary power functioning unit 39 is also configured to distribute operation power (e.g., current) to processing circuit 44 via ₒᵣgate₂. Secondary power functioning 39 unit may distribute any suitable voltage necessary according to specifications required to energize the hold-in coils efficiently in response to the ignition being turn to the START position. For instance, secondary power functioning unit 39 may provide anywhere in the range of 5.0V to 12V. Further, ₒᵣgate₁ obtains operation power (e.g., current) from primary power functioning unit 3 and secondary power functioning unit 39 in cause to primary power functioning unit 3 and secondary power functioning unit 39 being respectively couple to ₒᵣgate₁. And ₒᵣgate₂ obtains operation power (e.g., current) from secondary power functioning unit 39 and primary functioning unit 39 in cause to primary power functioning unit 3 and secondary power functioning unit 39 being respectively coupled to ₒᵣgate₂. Further, ₒᵣgate₁ and ₒᵣgate₂ distributes the operation power (e.g., current) on an single path due to different voltage levels and voltage levels increasing and rising at any giving interval varying on one or more operational phases.

Any suitable gate may be used to obtain and distribute operation power throughout power-link apparatus 64 and intelligent automotive component 1.

Further, processing circuit 44 can be configured to obtain operational power (e.g., current) via ₒᵣgate₁ and distribute an predetermine voltage to each respective electrical component according to the requirements to energize each respective electrical component of power-link apparatus 64. Processing circuit 44 may comprise any suitable voltage regulators, resistor, transistors, capacitors, inverters, logic gates etc. configure to obtain input power (e.g., current) via ₒᵣgate₁ and output an voltage to each respective electrical component (e.g., transceiver and processor(s) 6 etc.) of power-link apparatus 64 at an predetermine range. For instance, 2.7V may be supplied to processor(s) 6 and 2.7V may be distributed to transceiver etc. Additionally, secondary power functioning unit 39 can be configured to distribute an operational power (e.g., current) to processing circuit 44 via ₒᵣgate₁ in some instances. In the preferred embodiment of the present invention, when power-link apparatus 64 obtains an remote activation request signal (RARS) via control apparatus 1000 secondary power functioning unit 39 distributes power (e.g., current) to portion B hold-in 59. This is accomplished based upon processor(s) 6 distributing an first switch control signal (FSCS) to power functioning controller 42, upon power functioning controller 42 obtaining first switch control signal (FSCS) power functioning controller 42 is configured to generate and distribute a power signal to switch circuit ₃41 to close the circuitry of power signal path 974 in order to allocate power (e.g., current) to portion B hold-in 59 via ₒᵣgate₂. Also, upon power functioning controller 42 obtaining first switch control signal (FSCS) power functioning controller 42 doesn't generate and distribute a power signal to switch circuit ₅37 opening the circuitry of power signal path 975 in order to restrict voltage power to processing circuit 44 via ₒᵣgate₁.

In addition, when power-link apparatus 64 obtains remote activation request signal (RARS) via control apparatus 1000 primary power functioning unit 3 distributes operational power (e.g., current) to processing circuit 44. This is accomplished based upon processor(s) 6 generating and distributing an second switch control signal (SSCS) to power functioning controller 20, upon power functioning controller 20 obtaining second switch control signal (SSCS) power functioning controller 20 is configured to generate and distribute a power signal to switch circuit ₆45 to close the circuitry of the power signal path 976 in order to allocate operational power (e.g., current) to processing circuit 44 via ₒᵣgate₁. Also, upon power functioning controller 20 obtaining second switch control signal (SSCS) power functioning controller 20 doesn't generate and distribute a power signal to switch circuit ₂31 restricting voltage power to portion B hold-in 36 via ₒᵣgate₂. During this operational stage operational main power is distributed to processing circuit 44 by primary power functioning unit 3 via ₒᵣgate₁.

However, when power-link apparatus 64 obtains an remote deactivation request signal (RDRS) via control apparatus 1000 secondary power functioning unit 39 restricts voltage power (e.g., current) to portion B hold-in 36. This is accomplished based upon processor(s) 6 distributing an first switch control signal (FSCS) to power functioning controller 42, upon power functioning controller 42 obtaining first switch control signal (FSCS) power functioning controller 42 doesn't generate and distribute a power signal to switch circuit ₃41 opening the circuitry of power signal path 974 in order to restrict power (e.g., current) to portion B hold-in 36 via ₒᵣgate₂.

Also, upon power functioning controller 42 obtaining first switch control signal (FSCS) power functioning controller 42 doesn't generate and distribute a power signal to switch circuit ₅37 to open the circuitry of the power signal path 975 in order to restrict power (e.g., current) to processing circuit 44 via ₒᵣgate₁.

Including, when power-link apparatus 64 obtains remote deactivation request signal (RDRS) via control apparatus 1000 primary power functioning unit 3 distributes operational power (e.g., current) to processing circuit 44. This is accomplished based upon processor(s) 6 generating and distributing an second switch control signal (SSCS) to power functioning controller 20, upon power functioning controller 20 obtaining second switch control signal (SSCS) power functioning controller 20 is configured to generate and distribute a power signal to switch circuit ₆45 to close the circuitry of the power signal path 976 in order to allocate operational power (e.g., current) to processing circuit 44 via ₒᵣgate₁. Also, upon power functioning controller 20 obtaining second switch control signal (SSCS) power functioning controller 20 doesn't generate and distribute a power signal to switch circuit ₂31 opening the circuitry of the power signal path 977 in order to restrict voltage power to portion B hold-in 59 via ₒᵣgate₂. Also, during this operational stage operation main power is distributed to processing circuit 44 by primary power functioning unit 3 via ₒᵣgate₁.

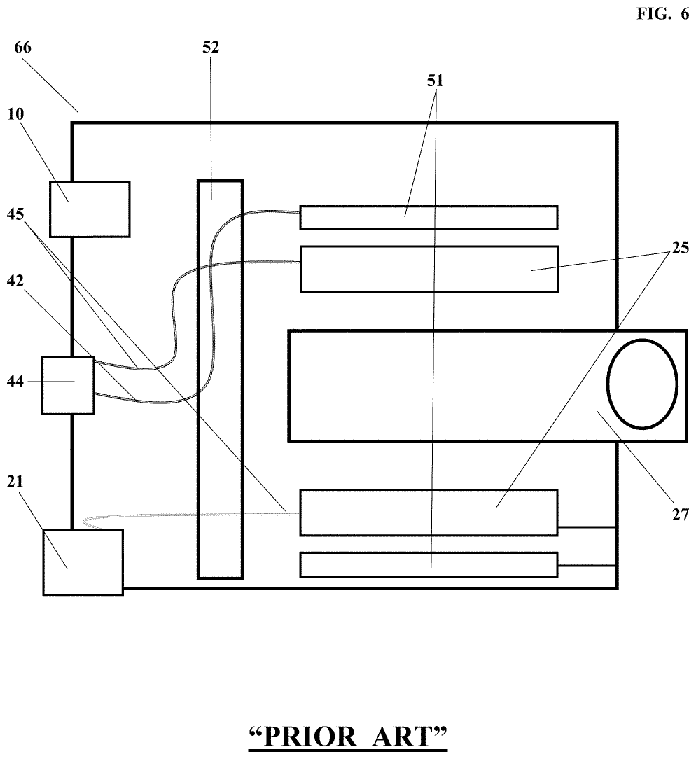

FIG. 6 illustrates an sample exemplary block diagram of a prior arts conventional manufacturing structing and operation of a engine-starter solenoid used in contrast with the present invention.

Specifically, solenoid 66 includes 3 respectively terminals mount thereon; B+ terminal 10, S terminal 44 and M terminal 21. B+ terminal 10 is connected directly to automobile battery positive via a terminal wire respectively. S terminal 44 obtains power from ignition switch either directly or indirectly with an relay. S terminal 44 respectively connects to pull-in windings 25 and hold-in windings 51 via pull-in coil terminal wire 45 and hold-in coil terminal wire 42. Specifically, pull-in and hold-in windings are coils of wire wrapped around plunger 27, which when energized they produce and electromagnet. Pull-in winding 25 are made up of thicker windings that creates an strong electromagnet and can be grounded through M terminal 21 and starter motor. Hold-in winding 51 are smaller and create a weaker electromagnet further grounded directly to an inner portion of starter. Plunger 27 sits in the middle of the windings and is held in place by a spring. Plunger 27 gets pulled/held in by the windings when they are energized. At one end plunger 27 is connected to a lever which forces the starter pinion gear to mesh with the ring gear. At the other end, when plunger 27 reaches the end of its travel, it pushes contact disk 52 which connects B+ terminal 10 to M terminal 21 which is connected to the starter motor. This energizes the starter motor and also causes pull-in winding 25 to stop flowing power. This may occur once contact disk 52 connects B+ to M there is 12v on both sides of pull-in winding 25 and no ground. Hold-in winding 51 continues to flow electricity and holds plunger 27 in place until the key is returned to the run position at the ignition.

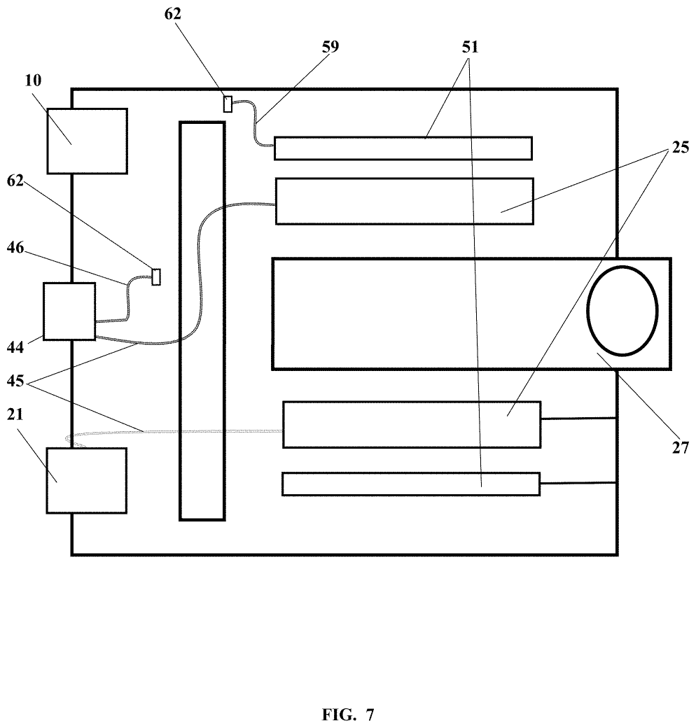

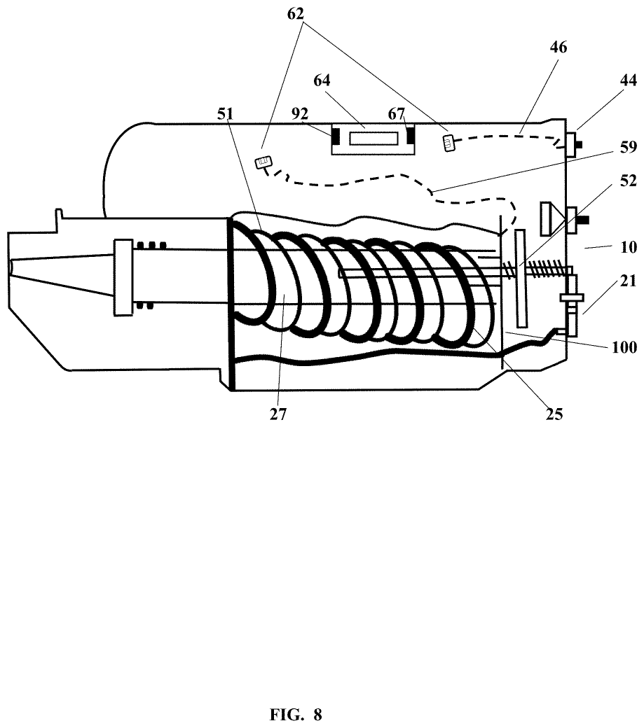

FIGS. 7 & 8 illustrates an block diagram of the current conventional manufacturing structing of intelligent automotive component 1 engine-starter solenoid 66.

In the current disclosure, intelligent automotive component 1 comprises solenoid 66 coupled to engine-starter, solenoid 66 includes portion A hold-in 46 coupled to S terminal 44 and portion B hold-in 59 extending from the spoil of hold-in windings 51 held in place by flange 100. Solenoid 66 includes B+ terminal 10 connected directly to automobile battery positive via a terminal wire. S terminal 44 obtains power from ignition switch either directly or indirectly with engine starter relay. S terminal 44 connects to pull-in windings 25 via pull-in coil terminal wire 45.

S terminal 44 is also connected to hold-in coil windings 51 via portion A hold-in 46. Pull-in windings 25 and hold-in windings 51 are coils of wire wrapped around plunger 27, which when energized they produce and electromagnet. Plunger 27 disposed in the middle of pull-in windings 25 and hold-in windings 51 held in place by a spring. Contact disk 52 connects B+ terminal 10 to M terminal 21 which is connected to engine starter.

According to the present invention, specifying hold-in coil at S terminal 44, as shown in the current disclosure is bifurcated into two portions, portion A hold-in 46 and portion B hold-in 59. Portion A hold-in 46 signifies where the coil is respectively affixed at S terminal 44, while portion B hold-in 59 signifies where the excess coil respectively deviates the spoil of hold-in coil(s) 51. Portion A hold-in 46 and portion B hold-in 36 comprises electrical connector 62 communicable coupled to power input/output device 67 & 92 electrical port to obtain and distribute power (e.g., current) to one or more components of power-link apparatus 64, and to distribute power (e.g., current) to hold-in windings 51 via portion B hold-in 59 to start the automobile thereof.

Electrical connector 62 of portion A hold-in 46 can include one or more pin(s), where at lease one pin(s) obtains input power (e.g., current) from S terminal 44 and input power (e.g., current) to keep power-link apparatus 64 circuitry operating when the ignition is at the OFF, ACC, RUN or START position via the electrical connector 62 of portion A hold-in 46 mating with power input/output device 67 electrical port. Electrical connector 62 of portion B hold-in 59 can include one or more pin(s), where at lease one pin(s) obtains output power (e.g., current) from power-link apparatus 64 and output power (e.g., current) to hold-in windings 51 to generate an electromagnetic field to energize hold-in windings 51 to start the automobile when the ignition is at the START position.

Electrical connector 62 disclosed in the present invention can be a electrical connector as described in U.S. patent application Ser. No. 11/296,437, filed Dec. 8, 2005, U.S. patent application Ser. No. 15/218,168, filed Jul. 25, 2016, the content of which is incorporated herein by reference in its entirety or any other automotive electrical connector known to one skilled in the art(s).

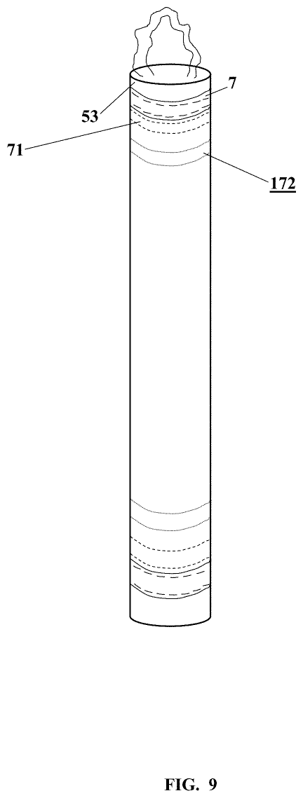

Referring to FIG. 9, in some implementations portion A hold-in 46 and portion B hold-in 59 can be respectively insulated with non-conductive first coat 53, sleeve 71 followed by an second coat 66 made of materials such as rubber, enamel or silicone to prevent the currents from passing between the coil turns. First coat 53 can cover the predominant region of portion A hold-in 46 and portion B hold-in 59, first coat 53 can comprise a 1.79 mm to 3.56 mm thickness respectively corresponding with portion A hold-in 46 and portion B hold-in 59 coil region. Sleeve 71 usually covers first coat 52 covering an partial portion of first coat 53 leaving approximately 5 mm of first coat 53 opposing ends freely of sleeve 71 portion accordingly, sleeve 71 can comprises a 1.79 mm thickness respectively corresponding with the first coat 53 portion A hold-in 46 and portion B hold-in 59 coil region. More of, second coat 66 covers a partial region of sleeve 71 leaving approximately 5 mm of sleeve 71 opposing ends freely of second coat 66 portion accordingly, second coat 66 can comprise an 1.79 mm to 3.56 mm thickness respectively corresponding with sleeve 71 and first coat 53 of portion A hold-in 46 and portion B hold-in 59 coil region. The process and or manufacturing method of joining first coat 53, sleeve 71 and second coat 66 together may be by way of an adhesive or lamination process and is not limited to any other method(s) known to one skilled in the art(s). Precisely, the insulated region of portion A hold-in 46 may relate to where distal ends of the coats and sleeves meet a distal end of S terminal 44 and connector 62, where the first coat 52 sleeve 53 and second coat 66 arranges adjacently inward the end cap(s) 7.

Portion A hold-in 46 and portion B hold-in 59 can comprise end caps 7 at opposing ends that seals and insulate the coil termination. End caps 7 can be a metal, copper or aluminum cap, boot, crimp sleeve or tubbing that is further compressed, clamped, heat shrink or affixed at the distal edges of the coil insulation by an adhesive or any other joining method known to one skilled in the art(s). End caps 7 can comprise a partial opening at a upper region allocating an insulated and/or non-insulated portion of portion A hold-in 46 and portion B hold-in 59 to deviate from end caps 7. More of, portion A hold-in 46 can comprises an cylinder shape end cap 7 arranging at an distal end whereby an insulated portion of portion A hold-in 46 can deviate end cap 7 and join a electrical connector by way of soldering or any other joining method known to one skilled in the art(s).

A non-insulated portion of portion A hold-in 46 can deviate end caps 7 and join to S terminal 44.

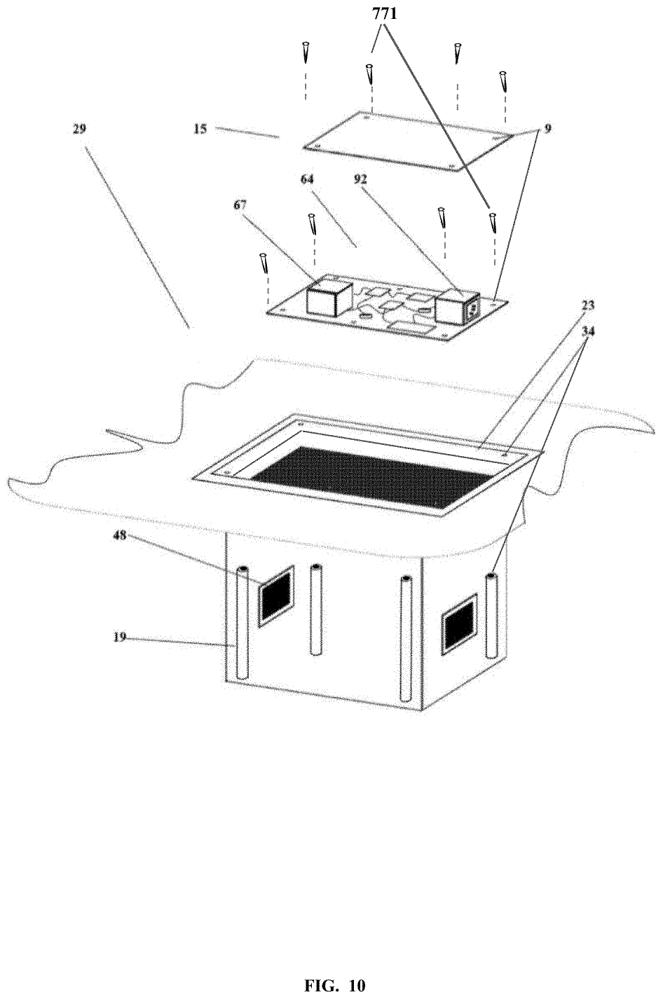

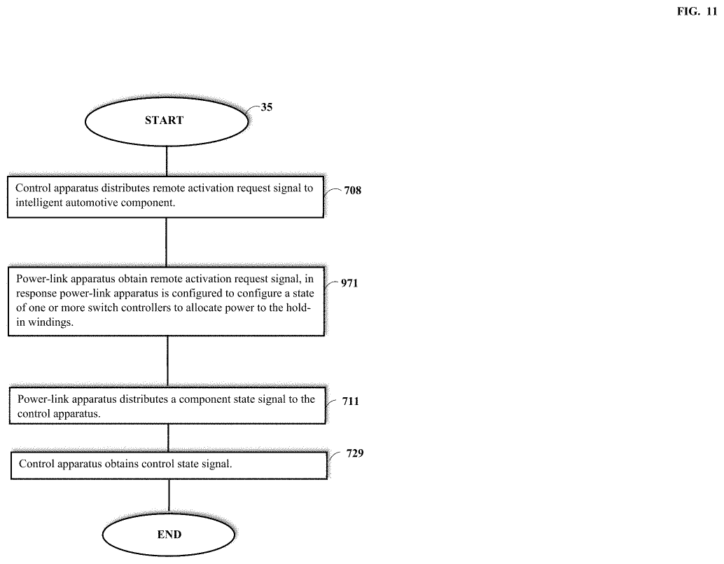

Referring to FIG. 10 is a cutout view illustrating engine-starter solenoid housing 29, solenoid housing 29 composes recessed region 69 at a top region of its body forming an unfilled region, recessed region 69 top edges forms grooved region 23 extending inwardly away from recessed region 69. Recessed region 69 can be of elliptical, quadrilateral or spherical shape. Grooved region 23 of recessed region 69 composes a plurality of recessed threaded opening 34 arranged thereon boarding grooved region 23 surface partial adjacent its outer edges. More of, a inner region of recessed region 69 forms four parallel cylinder-shaped stubble mount(s) 19 that directs perpendicular in direction ending adjacent of recessed opening, arranging at opposing corners within recessed region 69. Each stubble mount(s) 19 includes recessed threaded opening 34 at a top side of its body, the small openings of power-link apparatus 64 symmetrically assembles with recessed threaded openings 34 of stubble mounts 19 affixing power-link apparatus 64 within recessed region 69 by screws 771.

Recessed region 69 includes two inlet(s) 48 at opposing regions, at one side inlet 48 obtains power input/output device 67 port 24 from the interior of recessed region 69 configured to receive electrical connector of portion A hold-in from a interior of solenoid housing 29. The opposing inlet 48 obtains power input/output device 92 port 24 from the interior of recessed region 69 configured to receive electrical connector portion B hold-in from a interior of solenoid housing 29.

Solenoid housing 29 includes reedy plate 15 assembled on top of recessed region 69 grooved region 23 enclosing recessed region 69. Plate 15 comprises plurality of small openings 9 arranged thereon boarding its surface adjacent outer edges corresponding with grooved region 23 recessed threaded openings 34, screws can be introduced into plate 15 openings 9 and further crumpled into the grooved region 23 recessed threaded openings 34. Plate 15 can be elliptical, quadrilateral or spherical shape corresponding to the shape of recessed region 69 opening.

Power-link apparatus 64 of the current invention can be understood as a printed-circuit board. Specifically, power-link apparatus 64 comprises a plurality of small openings 9 around the outer edges of its body corresponding with recessed threaded openings 34 of stubble mount 19. Screws 771 can be introduce within openings 9 an crumpled to recessed threaded openings 34 affixing power-link apparatus 64 to stubble mount(s) 19. Screws 771 can be introduce to openings 9 of plate 15 and crumpled to recessed threaded openings 34 of grooved region 23 enclosing recessed region 69.

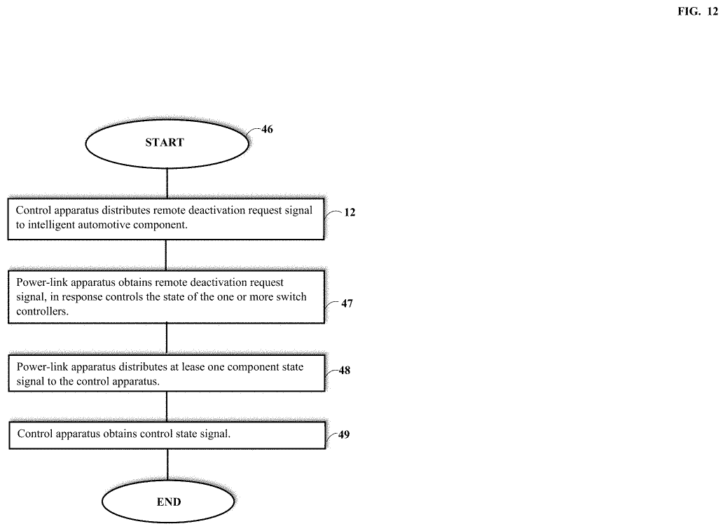

FIG. 11 is a flowchart of a process for remotely activating intelligent automotive component 1 in accordance with an exemplary embodiment of present invention. In the current disclosure when the phrase “IAC Activated” is used this phrase refers to when power (e.g., current) is supplied to the hold in coils of the intelligent automotive component 1, and when the phrase “IAC Deactivated” is used this phrase refers to when power (e.g., current) is restricted at the hold in coils of the intelligent automotive component 1.

As described in FIGS. 4A-5, in method 35 control apparatus 1000 distributes an respective activation request signal to power-link apparatus 64 of intelligent automotive component 1 via CA transceiver 17, upon power-link apparatus 64 obtaining the respective activation request signal via processor(s) 6, processor(s) 6 is configured to control the state of one or more switch circuits to allocate or restrict power (e.g., current) to portion B hold-in 59, and distribute one or more notifications to control apparatus 1000 via IAC transceiver 17.

Method 35 begins with the user of control apparatus 1000 distributing an remote activation request signal (RARS) to allocate power (e.g., current) to portion B hold-in 59 of intelligent automotive component(s) 1. In a preferred embodiment, an user may distribute the remote activation or deactivation request signal by physical interaction with an input button disposed on control apparatus 30 (e.g., key fob) or otherwise manipulating processing system 5 of FIG. 1 at 708.

At 971, power-link apparatus 64 of intelligent automotive component 1 obtains remote activation request signal (RARS) via transceiver 17. In response to obtaining the remote activation request signal (RARS) processor(s) 6 is configured to generate and distribute an first switch control signal (FSCS) to power functioning controller 42, upon power functioning controller 42 obtaining first switch control signal (FSCS) power functioning controller 42 is configured to generate and distribute a power signal to switch circuit ₃41 to close circuitry of power signal path 974 in order to allocate power (e.g., current) to portion B hold-in 59 via ₒᵣgate₂.

Also, upon power functioning controller 42 obtaining first switch control signal (FSCS) power functioning controller 42 doesn't generate and distribute a signal to switch circuit ₅37 keeping the circuitry of power signal path 975 open in order to restrict voltage power (e.g., current) to processing circuit 44 via ₒᵣgate₁.

More of, upon obtaining the remote activation request signal processor(s) 6 generates and distributes a second switch control signal (SSCS) to power functioning controller 20, upon power functioning controller 20 obtaining second switch control signal (SSCS) power functioning controller 20 is configured to generate and distribute a power signal to switch circuit ₆45 to close the circuitry of power signal path 976 in order to allocate operational power (e.g., current) to processing circuit 44 via ₒᵣgate₁. Further, upon power functioning controller 20 obtaining second switch control signal (SSCS) power functioning controller 20 doesn't generate and distribute a power signal to switch circuit ₂31 in response opening the circuitry of power signal path 977 in order to restrict voltage power (e.g., current) to portion B hold-in 59 via ₒᵣgate₂. During this operational stage operation main power is distributed to processing circuit 44 by primary power functioning unit 3 via ₒᵣgate₁.

At 711, in response to processor(s) 6 activating intelligent automotive component 1 via distributing first switch control signal (FSCS) to power functioning controller 42 controlling the state of switch circuit ₃41 to close the circuitry of power signal path 974 allocating voltage power (e.g., current) to portion B hold-in 59 via ₒᵣgate₂. Processor 6 of power-link apparatus 1 is configure generate and distribute a component state signal (CSS) to control apparatus 1000 regarding the state of intelligent automotive component 1 under the control of processor(s) 6.

The component state signal (CSS) comprises data revealing the current status of the intelligent automotive component 1. For instance, intelligent automotive component state signal can be an notification indicating the word “IAC Activated”.

At 729, control apparatus 1000 is configured to obtain component state signal (CSS) via CA transceiver 14 under the control of processor(s) 32, in response application 24 is configured to obtain component state signal (CSS) and display the current status of intelligent automotive component 1 on display 10, wherein the components state signal (CSS) can be the phrase “IAC Activated”. This phrase and number value may be displayed on an side panel, drop down menu or first screen of display 10, other suitable indications may be displayed to notify the user the state of intelligent automotive component 1.

FIG. 12 is a flowchart of a process for remotely deactivating an intelligent automotive component 1 in accordance with an exemplary embodiment of the present invention. The method 46 comprises the steps of control apparatus 1000 distributing an respective remote deactivation request signal (RDRS) to power-link apparatus 64 of intelligent automotive component 1 via CA transceiver 17, upon power-link apparatus 64 obtaining the respective remote deactivation request signal (RDRS) processor(s) 6 is configured to control the state of one or more switch circuits to restrict voltage power (e.g., current) to portion B hold-in 59 and to allocate power (e.g., current) to processing circuitry 44, and distribute one or more notifications to control apparatus 1000.

At 12, the user of control apparatus 1000 distributes an remote deactivation request signal (RDRS) to restrict power (e.g., current) to portion B hold-in 59 of intelligent automotive component(s) 1 (step 47). In a preferred embodiment, an user may distribute the remote deactivation request signal (RDRS) by physical interaction with an input button disposed on control apparatus 30 (e.g., key fob) or otherwise manipulating processing system 5 of FIG. 1.

At 47, power-link apparatus 64 of intelligent automotive component 1 obtains the respective remote deactivation request signal (RDRS) via transceiver 9. In response to obtaining the remote deactivation request signal (RDRS) processor(s) 6 generates and distributes an first switch control signal (FSCS) to power functioning controller 42, upon power functioning controller 42 obtaining first switch control signal (FSCS), power functioning controller 42 doesn't generate and distribute a power signal to switch circuit ₃41 opening the circuitry of power signal path 974 in order to restrict voltage power (e.g., current) to portion B hold-in 59 via ₒᵣgate₂. Also, power functioning controller 42 doesn't generate and distribute a signal to switch circuit ₅37 opening the circuitry of power signal path 975 in order to restrict voltage power to processing circuit 44 via ₒᵣgate₁.

In addition, when power-link apparatus 64 of intelligent automotive component 1 obtains remote deactivation request signal (RDRS) primary power functioning unit 3 distributes operational power (e.g., current) to processing circuit 44. Further, processor(s) 6 generates and distributes an second switch control signal (SSCS) to power functioning controller 20, upon power functioning controller 20 obtaining second switch control signal (SSCS) power functioning controller 20 is configured to generate and distribute a power signal to switch circuit ₆45 to close the circuitry of power signal path 976 in order to allocate operational power (e.g., current) to processing circuit 44 via ₒᵣgate₁. Also, upon power functioning controller 20 obtaining second switch control signal (SSCS) power functioning controller 20 doesn't generate and distribute a power signal to switch circuit ₂31 opening the circuitry of power signal path 977 in order to restrict voltage power to portion B hold-in 36 via ₒᵣgate₂. At 48, in response to processor(s) 6 deactivating intelligent automotive component 1 via distributing an first switch control signal (FSCS) to power functioning controller 42 controlling the state of switch circuit ₃41 opening the circuitry of power signal path 974 restricting voltage power (e.g., current) to portion B hold-in 59 via ₒᵣgate₂, and distributing an second switch control signal (SSCS) to power functioning controller 20 restricting voltage power (e.g., current) to portion B hold-in 36 via ₒᵣgate₂ by way of controlling the state of switch circuit₂ 31 opening the circuitry of power signal path 977 in order to restrict voltage power (e.g., current) to ₒᵣgate₂. Power-link apparatus 64 of intelligent automotive component 1 generates and distributes an respective component state signal (CSS) to control apparatus 1000 regarding the status of intelligent automotive component 1 under the control of one or more processor(s) 6.

For instance, the component state signal is an notification indicating the word “IAC Deactivated”.

At 49, control apparatus 1000 is configured to obtain the component state signal (CSS) via CA transceiver 17 under the control of one or more processor(s) 32, in response processor(s) 32 is configured to obtain the component state signal (CSS) and display the current status of intelligent automotive component 1 on display 10, wherein during deactivation component state signal (CSS) is the phrase “IAC Deactivated”. This phrase may be displayed on an side panel, drop down menu or first screen of display 10, other suitable indications may be displayed to notify the user the state of intelligent automotive component 1.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention. In particular, with respect to the above description, it is to be realized that the optimum dimensional relationships for the parts of the present invention may included variations in size shape form function and manner of operation. The assembly and use of the present invention are deemed readily apparent and obvious to one skilled in the art.

Having described my invention, I claim:

1. An automobile having a intelligent automotive component, the intelligent automotive component comprising:
a solenoid coupled to a engine starter, wherein the solenoid includes a housing composing an recess slightly extending downward in the housing forming an hollow region, wherein the recess of the housing includes a plurality of stubble mounts at a base for coupling a power-link apparatus to the recess of the housing; and wherein the recess of the housing comprises respective inlets at opposing sides of an lower side of the recess, wherein the inlets of the recess is configured to receive a power input/output device of the power-link apparatus to communicable couple a portion A hold-in and portion B hold-in to the power input/output device;
an control apparatus configured to distribute a signal to the power-link apparatus;
a gate coupled to one or more switch circuits via an power signal path, wherein the gate is configured to distribute power to a hold-in winding based upon the power-link apparatus obtaining a remote activation signal, a switch circuit of an secondary power functioning unit closing the circuit of a signal path upon obtaining a power signal via the controller and a battery terminal/external power supply distributing power to the power-link apparatus; wherein the gate is configured to distribute power to a processing circuit based upon the power-link apparatus obtaining the remote activation or deactivation signal and the switch circuit of the primary power functioning unit closing the circuit of the signal path upon obtaining the power signal via the controller and the battery terminal/external power supply distributing power to the power-link apparatus; and wherein the gate is configured to restrict power to the hold-in winding based upon the power-link apparatus obtaining the remote deactivation signal and the switch circuit of the secondary power functioning unit opening the circuit of the signal path whereby the controller doesn't distribute the power signal to the switch circuitry of the signal path;
wherein the intelligent automotive component is constructed in a way such that power is perpetually distributed to the power-link apparatus via the battery terminal/external power supply when the ignition is at an OFF position, and wherein the power distributed to the power-link apparatus via the battery terminal/external power supply based upon a engine starter relay having an switch positioned at an close position allocating power from the battery terminal/external power supply to flow to the power-link apparatus and the switch circuit of a primary power functioning unit allocating power to the processing circuit when the ignition is position at the OFF position;
wherein the recess of the housing comprises a plate enclosing the recess of the housing, and wherein the plate assembles within the groove of the recess, wherein the plate of the recess comprise a plurality of small openings boarding a outer edge, and wherein the plate is affixed to the recess of the housing by screws;
wherein the portion A hold-in of the intelligent automotive component is configured to obtain input power from the battery terminal/external power supply and supply power to the power-link apparatus, and wherein the power obtained by the portion A hold-in is based upon the ignition being at an OFF, ACC or START position; and wherein the portion B hold-in is configured to output power from the power-link apparatus to a hold-in windings based upon the power-link apparatus obtaining the remote activation signal, the ignition being at the START position, one or more switch circuits obtaining the power signal via a controller of the secondary power functioning unit and a switch of the switch circuit closing the circuit of the power signal path to allocate power to the hold-in windings;
wherein the power-link apparatus is configured in a way such to restrict power to the hold-in winding via the portion B hold-in based upon the power-link apparatus obtaining the remote deactivation signal, the controller of the secondary power functioning unit not distributing the power signal to the one or more switch circuit causing the switch of the switch circuit to open the circuit of the power signal path to restrict power to the hold-in windings.

2. The intelligent automotive component of claim 1, wherein the recess is of an elliptical, quadrilateral or spherical shape.

3. The intelligent automotive component of claim 1, wherein the control apparatus is an key fob.

4. The intelligent automotive component of claim 1, wherein the grooved of the recess composes an plurality of recessed threaded openings.

5. The intelligent automotive component of claim 1, wherein the stubble mount(s) comprises the recessed threaded opening at a top side of a body.

6. The intelligent automotive component of claim 1, wherein the plate is of an elliptical, quadrilateral or spherical shape.

7. The intelligent automotive component of claim 1, wherein the portion A hold-in and portion B hold-in comprising a electrical connector

8. The intelligent automotive component of claim 1, wherein the portion A hold-in relates to where a wire is respective coupled to a S terminal; and wherein the portion B hold-in relates to where the wire deviates the spoil of hold-in windings.

9. A method for remotely activating a intelligent automotive component, the method comprising:
obtaining, by one or more processors of a power-link apparatus, a respective remote activation request signal via a control apparatus, and wherein upon the one or more processors of the power-link apparatus obtaining the remote activation request signal the one or more processors of the power-link apparatus is configured to generate and distribute a first switch control signal to a controller of a secondary power functioning unit, and wherein the controller of the secondary power functioning unit is configured to distribute a power signal to a switch circuit to allocate the power signals to portion B hold-in via ₒᵣgate² wherein a switch of the switch circuit closes the power signal path of the switch circuit, and also upon the controller of the secondary power obtaining the first switch control signal the controller doesn't distribute the power signal to the switch circuit wherein the switch of the switch circuit opens the power signal path of the switch circuit in order to restrict power signals to a processing circuit via ₒᵣgate¹; and wherein upon the one or more processors of the power-link apparatus obtaining the remote activation request signal the one or more processors of the power-link apparatus is configured to generate and distribute a second switch control signal to the controller of the primary power functioning unit, and wherein the controller of the primary power functioning unit is configured to distribute the power signal to a switch circuit to allocate the power signal to the processing circuit via ₒᵣgate¹ wherein the switch of the switch circuit closes the power signal path of the switch circuit, and also upon the controller of the primary power functioning unit obtaining the second switch control signal the controller doesn't distribute the power signal to the switch circuit wherein the switch of the switch circuit opens the power signal path of the switch circuit in order to the restrict power signal to the portion B hold-in via ₒᵣgate²; and
distributing, by the one or more processors of the power-link apparatus, a component state signal to the control apparatus to notify a user of the control apparatus a current state of the intelligent automotive component.

10. A method for remotely deactivating a intelligent automotive component, the method comprising:
obtaining, by one or more processors of a power-link apparatus, a remote deactivation request signal via a control apparatus, and wherein upon the one or more processors of the power-link apparatus obtaining the remote deactivation request signal the one or more processors of the power-link apparatus is configured to generate and distribute a first switch control signal to a controller of a secondary power functioning unit, and wherein the controller of the secondary power functioning unit doesn't distribute a power signal to a switch circuit to restrict a power signal to portion B hold-in via ₒᵣgate² wherein a switch of the switch circuit opens the power signal path of the switch circuit, and also upon the controller of the secondary power obtaining the first switch control signal the controller doesn't distribute the power signal to the switch circuit wherein the switch of the switch circuit opens the power signal path of the switch circuit in order to restrict power signals to a processing circuit via ₒᵣgate¹; and wherein upon the one or more processors of the power-link apparatus obtaining the remote deactivation request signal the one or more processors of the power-link apparatus is configured to generate and distribute the second switch control signal to the controller of a primary power functioning unit, and wherein the controller of the primary power functioning unit is configured to distribute the power signal to a switch circuit to allocate the power signal to the processing circuit via ₒᵣgate¹, wherein the switch of the switch circuit closes the power signal path of the switch circuit, and also upon the controller of the primary power functioning unit obtaining the second switch control signal the controller doesn't distribute the power signal to the switch circuit wherein the switch of the switch circuit opens the power signal path of the switch circuit in order to restrict power signals to the portion B hold-in via ₒᵣgate²; and
distributing, by the one or more processors of the power-link apparatus, a component state signal to the control apparatus to notify a user of the control apparatus a current state of the intelligent automotive component.
